(19) United States
(12) Patent Application Publication
(10) Pub. No.: US 2024/0116796 A1
(43) Pub. Date: Apr. 11, 2024

(54) SYSTEM AND METHODS FOR ADJUSTABLE EDGE COOLING MEANS FOR SLOT GLASS DRAWDOWN

(71) Applicant: CORNING INCORPORATED, CORNING, NY (US)

(72) Inventors: ZAKARIA ALLAM, AVON (FR); ANTOINE GASTON DENIS BISSON, PAINTED POST, NY (US); CHRISTOPHE PIERRON, AVON (FR)

(21) Appl. No.: 18/276,387

(22) PCT Filed: Feb. 7, 2022
(86) PCT No.: PCT/US2022/015397

§ 371 Date: Aug. 8, 2023

Related U.S. Application Data
(60) Provisional application No. 63/148,334, filed on Feb. 11, 2021.

(51) Int. Cl. C03B 17/06

(52) U.S. Cl. CPC C03B 17/067; C03B 17/064

(57) ABSTRACT

Apparatuses and methods are described for controlling the width and thickness of glass during glass sheet production. The apparatuses and methods employ a gas cooling mechanism that is designed to extract heat from molten glass during the drawdown process to reduce width attenuation and generate more uniform glass. In some examples, a nozzle of a glass forming apparatus includes a first nozzle portion with a first glass forming surface, and a second nozzle portion opposite the first nozzle portion, where the second nozzle portion includes a second glass forming surface opposite the first glass forming surface. The nozzle also includes a first cavity within the first nozzle portion, and a second cavity within the second nozzle portion. Gas, such as air, is delivered to each of the first cavity and the second cavity to cool molten glass as it is drawn between the first and second glass forming surfaces.

### CROSS-REFERENCE TO RELATED APPLICATION

This application claims the benefit of priority under 35 U.S.C. § 119 of U.S. Provisional Application Ser. No. 63/148,334 filed on Feb. 11, 2021, the content of which is relied upon and incorporated herein by reference in its entirety.

### FIELD OF THE DISCLOSURE

The present disclosure relates to the production of glass sheets and, more particularly, to apparatus and methods for controlling the uniformity of glass during glass sheet production.

### BACKGROUND

Glass sheets are used in a variety of applications. For example, they may be used in glass display panels such as in mobile devices, laptops, tablets, computer monitors, and television displays. Glass sheets may be manufactured by a slot drawdown process whereby molten glass is drawn through a slot to form a glass sheet. For a variety of applications, the close control of the width and thickness of manufactured glass can be important. Thermo-mechanical and glass flow conditions can be uneven across the entirety or portions of a width of a glass ribbon as it is being formed in the slot drawdown process, thereby causing variations in the width or thickness of the formed glass. These width and thickness differences in the formed glass are, in many applications, undesirable as they may result in cost and time consequences that, in many cases, can be significant. As such, there are opportunities to improve the production of glass sheets.

### SUMMARY

The embodiments disclosed herein are directed to apparatus and methods for providing a cooling mechanism in glass formation apparatus during the glass formation process. The cooling mechanism may allow for the extraction of heat along a width of molten glass and, in particular, along and near either edge of the molten glass.

For example, the embodiments may control heat extraction along a width of molten glass by providing gas (e.g., air, oxygen, etc.) flow within portions of a nozzle that guides the molten glass during the drawdown process. The embodiments may, for example, increase the viscosity of the molten glass near and along the ends of the width of glass compared to more center regions of the width of glass. The embodiments may achieve the higher viscosity levels by controlling the amount of heat extracted from the molten glass as it is drawn down. For example, the embodiments may extract heat from portions of the molten glass near and along the ends of the width of glass to increase viscosity along those portions. The embodiments may extract the heat by providing higher gas flow within portions of the nozzle closer to the ends of the molten glass compared to any gas flow provided within portions of the nozzle that are closer to more center regions of molten glass.

Among other advantages, the embodiments may allow for the production of glass (e.g., ribbon) sheets with reduced width attenuation, thus allowing for the formation of glass sheets with more uniform widths. As a result, the embodiments may reduce cost and time consequences associated with generating glass with less uniform widths, including the reduction of glass waste and cost (e.g., such as when glass doesn't meet a width specification). Moreover, glass sheets, and in particular thin or ultrathin glass sheets (e.g., <200 microns thickness) can be more reliably formed. Those of ordinary skill in the art having the benefit of these disclosures may recognize other benefits as well.

In some examples, the apparatuses and methods described herein may employ a gas cooling mechanism that is designed to extract heat from molten glass during the drawdown process to reduce width attenuation and generate more uniform glass. For example, in some embodiments, a nozzle of a glass forming apparatus includes a first nozzle portion with a first glass forming surface, and a second nozzle portion opposite the first nozzle portion, where the second nozzle portion includes a second glass forming surface opposite the first glass forming surface. The nozzle also includes a first cavity within the first nozzle portion, and a second cavity within the second nozzle portion. Gas, such as air, is delivered to each of the first cavity and the second cavity to cool molten glass as it is drawn between the first and second glass forming surfaces.

In some embodiments, a nozzle assembly for a glass forming apparatus includes a first nozzle portion and a second nozzle portion opposite the first portion. The first nozzle portion includes a first glass forming surface, and the second nozzle portion includes a second glass forming surface opposite the first glass forming surface. The nozzle also includes a first cavity within the first nozzle portion, and a second cavity within the second nozzle portion.

In some embodiments, a glass forming apparatus includes a nozzle with a first nozzle portion and a second nozzle portion opposite the first portion. The first nozzle portion includes a first glass forming surface, and the second nozzle portion includes a second glass forming surface opposite the first glass forming surface. The nozzle also includes a first cavity within the first nozzle portion, and a second cavity within the second nozzle portion. The apparatus also includes at least one gas supply configured to deliver a gas to the first cavity and the second cavity.

In some embodiments, a glass forming apparatus includes a nozzle with a first nozzle portion and a second nozzle portion opposite the first portion. The first nozzle portion includes a first glass forming surface, and the second nozzle portion includes a second glass forming surface opposite the first glass forming surface. The nozzle also includes a first cavity within the first nozzle portion, and a second cavity within the second nozzle portion. The apparatus also includes at least one gas supply configured to deliver a gas to the first cavity and the second cavity. The apparatus further includes a thermal camera configured to detect a temperature of molten glass that flows between the first glass forming surface and the second glass forming surface. The apparatus further includes a processor configured to receive a signal from the thermal camera identifying a temperature of the molten glass, and determine a pressure for the gas based on the temperature. The processor is also configured to transmit a signal to the at least one gas supply to cause the at least one gas supply to provide the gas at the determined pressure.

In some embodiments, a method by a glass forming apparatus includes providing a first gas flow at a first pressure through a passageway of a first portion of a nozzle of a glass forming apparatus. The method also includes providing a second gas flow at a second pressure through a passageway of a second portion of the nozzle. Further, the method includes providing molten glass between the first and second glass forming surfaces to produce a glass ribbon. In some examples, the method further includes generating a laser beam towards molten glass that has flowed between the first and second glass forming surfaces.

In some embodiments, a method by one or more processors includes transmitting a first signal to cause a delivery of air flow at a first pressure through a cavity of a nozzle of a glass forming apparatus. The method also includes receiving a second signal that identifies a temperature of molten glass at a first edge of the molten glass. Further, the method includes determining a second pressure of air flow based on the first pressure and the temperature of the molten glass at the first edge. The method also includes transmitting a third signal to cause the delivery of the air flow at the second pressure through the cavity of the nozzle.

In some embodiments, a non-transitory computer readable medium stores instructions that, when executed by one or more processors, cause the one or more processors to perform a method that includes transmitting a first signal to cause a delivery of air flow at a first pressure through a cavity of a nozzle of a glass forming apparatus. The method also includes receiving a second signal that identifies a temperature of molten glass at a first edge of the molten glass. Further, the method includes determining a second pressure of air flow based on the first pressure and the temperature of the molten glass at the first edge. The method also includes transmitting a third signal to cause the delivery of the air flow at the second pressure through the cavity of the nozzle.

### BRIEF DESCRIPTION OF DRAWINGS

The above summary and the below detailed description of illustrative embodiments may be read in conjunction with the appended Figures. The Figures show some of the illustrative embodiments discussed herein. As further explained below, the claims are not limited to the illustrative embodiments. For clarity and ease of reading, Figures may omit views of certain features.

FIG. 1 schematically illustrates an exemplary glass forming apparatus with a gas cooling system in accordance with some examples.

FIGS. 2A and 2B illustrate exemplary portions of a glass cooling system for a glass forming apparatus in accordance with some examples.

FIG. 3 is a block diagram of an exemplary gas cooling and laser beam control system in accordance with some examples.

FIG. 4 illustrates exemplary portions of a glass cooling system for a glass forming apparatus in accordance with some examples.

FIG. 5 is a chart illustrating glass widths in response to gas flow rate changes in accordance with some examples.

FIG. 6 is a chart illustrating temperature changes along a width of glass in response to gas flow in accordance with some examples.

FIGS. 7A and 7B illustrate exemplary portions of a gas cooling system for a glass forming apparatus in accordance with some examples.

FIG. 8 illustrates an exemplary method for providing gas flow to a glass forming apparatus in accordance with some examples.

FIG. 9 illustrates exemplary method for controlling gas flow provided to a glass forming apparatus in accordance with some examples.

### DETAILED DESCRIPTION

The present application discloses illustrative (i.e., example) embodiments. The disclosure is not limited to the illustrative embodiments. Therefore, many implementations of the claims will be different than the illustrative embodiments. Various modifications can be made to the claims without departing from the spirit and scope of the disclosure. The claims are intended to cover implementations with such modifications.

At times, the present application uses directional terms (e.g., front, back, top, bottom, left, right, etc.) to give the reader context when viewing the Figures. The claims, however, are not limited to the orientations shown in the Figures. Any absolute term (e.g., high, low, etc.) can be understood as disclosing a corresponding relative term (e.g., higher, lower, etc.).

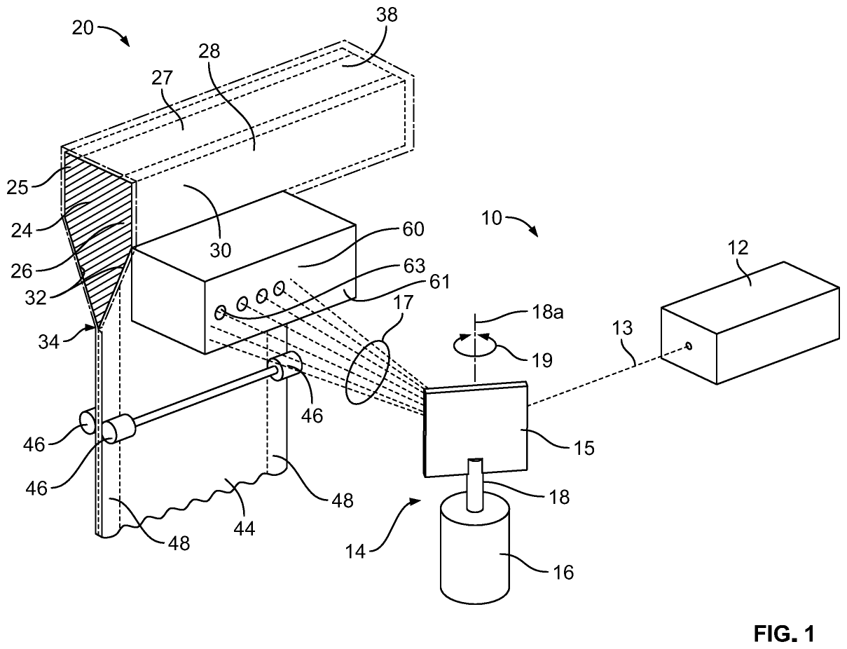

Referring to FIG. 1, glass forming apparatus 20 includes a cavity 24 that is bounded on its longitudinal sides by walls 25 and 26. The walls 25 and 26 terminate at their upper extent in opposed longitudinally extending overflow weirs 27 and 28, respectively. The walls 25 and 26 are integral with a nozzle 60 that includes pair of opposed and downwardly inclined glass forming surfaces 32. The pair of opposed and downwardly inclined glass forming surfaces 32 terminate at a slot 34 of nozzle 60. Molten glass is delivered into cavity 24 by means of a delivery passage 38 that is in fluid communication with the cavity 24. The molten glass is directed to the slot 34 by walls 25, 26 and the pair of opposed and downwardly inclined glass forming surfaces 32.

FIG. 1 illustrates one nozzle portion 61 of nozzle 60. Each nozzle portion 61 may, in some examples, include cold fingers (not illustrated) to extract heat from corresponding portions of the molten glass as the glass ribbon is being formed. For example, one or more cold fingers may be embedded into the nozzle portion 61 of nozzle 60 to extract heat from the molten glass through an adjacent portion of a corresponding downwardly inclined glass forming surface 32. Each cold finger may be manufactured from material that facilitates heat conductivity (e.g., thermal conduction), such as a metal. Further, each nozzle portion 61 may include one or more cavities 63. The cavities 63 may extend into the nozzle portion 61 in a direction towards a corresponding glass forming surface 32.

In some examples a cooling gas, such as air or oxygen, is provided to one or more cavities 63. For example, one end of a tube (e.g., plastic air tube) may be inserted into a cavity 63, and the other end of the tubes receive gas from a gas supply (e.g., air supply). The gas proceeds through the tube into the cavity 63, and extracts heat during the glass ribbon 44 formation process. In some examples, glass forming apparatus 20 includes one or more gas supply devices (not illustrated in FIG. 1). Each gas supply device may provide gas to one or more cavities 63. In some examples, the cavities 63 are positioned to align with edges 48, such that they allow for cooling of edges of the molten glass. In some examples, the cavities are positioned within 160 millimeters of an end of slot 34 (e.g., and substantially aligned with edges 48 of the glass ribbon 44).

Further, each cavity 63 may have a predetermined diameter, which can be determined based on a targeted (e.g., predetermined) amount of heat extraction. In some examples, the cavities 63 have a diameter smaller than 2 millimeters, such as when producing ultrathin glass sheets (e.g., less than 200 microns in glass thickness). Moreover, each cavity 63 may extend into nozzle portion 61 up to a predetermined distance from the corresponding downwardly inclined glass forming surface 32. For example, a cavity 63 may extend until a few millimeters (e.g., 2 to 10 mm) from the corresponding downwardly inclined glass forming surface 32. In some examples, the distance from the corresponding downwardly inclined glass forming surface 32 is determined empirically, and based on heat transfer properties and algorithms.

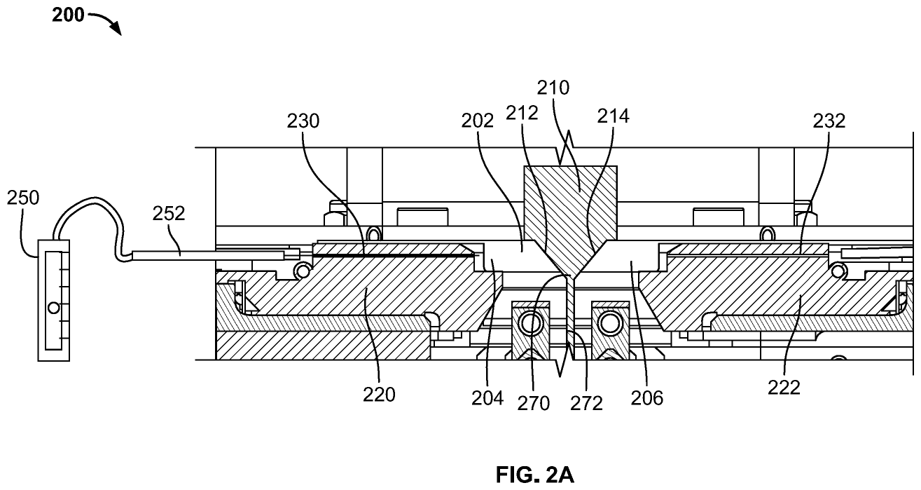

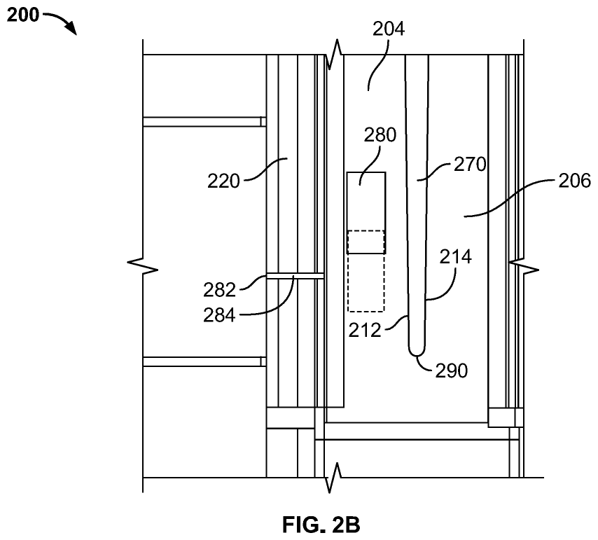

FIGS. 2A and 2B illustrate views of an exemplary nozzle assembly 200. For example, and with reference to FIG. 2A, nozzle assembly 200 includes a nozzle 202 with a first nozzle portion 204 and a second nozzle portion 206. Molten glass 210 is provided between a first glass forming surface 212 of first nozzle portion 204 and a second glass forming surface 214 of second nozzle portion 206, and flows through slot 270 to product a glass ribbon 272. In addition, the first nozzle portion 204 is supported by a first cradle portion 220 of a cradle assembly 218, and the second nozzle portion 206 is supported by a second cradle portion 222 of the cradle assembly 218. Each of the first cradle portion 220 and the second cradle portion 222 include a gas flow passageway. For example, first cradle 220 includes a first gas flow passageway 230, and second cradle portion 222 includes a second gas flow passageway 232.

Each of the first gas flow passageway 230 and second gas flow passageway 232 may be configured to receive a gas, such as air, and provides the gas to cavities (e.g., such as cavities 63) of the nozzle 202 (the cavities are not illustrated in FIG. 2A). For example, as illustrated in FIG. 2A, gas supply 250 provides a gas, such as air, through a gas tube 252 to first gas flow passageway 230. Gas supply 250 may provide the gas at a pressure, and the gas may flow through the gas tube 252, through the first gas flow passageway 230, and into one or more cavities of first nozzle portion 204.

In some examples, gas tubes 252 are manufactured from a metal or a metal oxide, such as alumina. In some examples, the initial part of a gas tube 252 connected to the gas supply (and, in some examples, coming from a gas flowmeter 64 as described herein) may be made out of metal with a diameter of 5-10 mm, to facilitate the passage of the gas towards a relatively hot environment as well as to increase mechanical stability. The final part of the gas tube 250 (with a length of 100-150 mm in some examples) needs to be small enough to pass through openings in the cradle assembly 218. These openings may be smaller (e.g., 2-3 mm) to minimize mechanical weakening of the cradle assembly 218. Connection of the gas tube 250 to the openings can be made by welding or brazing with a lower melting point alloy, for example.

FIG. 2B illustrates a cavity 284 of first nozzle portion 202. Cavity 284 includes an opening 282, and extends towards and first glass forming surface 212. In this example, gas provided by gas supply 250 extracts heat from cold finger 280, thereby increasing the amount of heat cold finger 280 extracts from the molten glass. In some examples, first nozzle portion 202 includes one or more cavities 284 adjacent a first distal end 290 of the slot 270, and second nozzle portion 204 includes one or more cavities 284 adjacent a second distal end (not illustrated) opposite the first distal end 290 of the slot 270.

Referring back to FIG. 1, the molten glass flows through slot 34 to form the glass ribbon 44. Pulling rolls 46 are located downstream of the slot 34 and engage side edges 48 at both sides of the glass ribbon 44 to apply tension to the glass ribbon 44. The pulling rolls 46 may be positioned sufficiently below the root 34 that the thickness of the glass ribbon 44 is essentially fixed at that location. The pulling rolls 46 may draw the glass ribbon 44 downwardly at a prescribed rate that establishes the thickness of the glass ribbon as it is drawn though slot 34.

In some examples, glass forming apparatus 20 includes a laser generator 12 that is configured to generate and emit a laser beam 13. In an embodiment, the laser beam 13 is directed to molten glass below (e.g., just below) slot 34, where the laser beam energy provided by laser beam 13 is provided across the molten glass. As illustrated in the aspect of FIG. 1, the laser beam 13 can be directed by laser generator 12 to the molten glass via, for example, reflecting apparatus 14. Although one laser generator 12 generating a laser beam 13 towards reflecting apparatus 14 is illustrated, in some examples, laser beam control system 10 may employ additional laser generators 12 and/or reflecting apparatus 14. For example, control system 10 may employ a second laser generator 12 to direct a laser beam to the molten glass via reflecting apparatus 14. As another example, laser beam control system 10 may employ a second laser generator 12 to direct a laser beam to the molten glass flowing from slot 34 via a second reflecting apparatus 14.

Further, reflecting apparatus 14 can include a reflecting surface 15 that is configured to receive the laser beam 13 generated and emitted by the laser generator 12 and reflected onto at least predetermined portions of the molten glass. Reflecting apparatus 14 may be, for example, a mirror configured to deflect a laser beam from laser generator 12. Reflecting apparatus 14 may therefore function as a beam-steering and/or scanning device. In FIG. 1, the laser beam 13 is illustrated as being advanced by reflecting apparatus 14 as reflected laser beams 17 to a plurality of portions (e.g., preselected portions) of the molten glass.

The reflecting surface 15 in one example can comprise a gold-coated mirror although other types of mirrors may be used in other examples. Gold-coated mirrors may be desirable under certain applications to provide superior and consistent reflectivity relative to infrared lasers, for example. In addition, the reflectivity of gold-coated mirrors is virtually independent of the angle of incidence of laser beam 13 and, therefore, the gold-coated mirrors are particularly useful as scanning or laser beam-steering mirrors.

The reflecting apparatus 14 in the embodiment illustrated in FIG. 1 may also include a regulating mechanism 16 (e.g., a galvanometer or polygon scanner) configured to adjust an orientation of the reflecting surface 15 of the reflecting apparatus 14 relative to the receipt of the laser beam 13 and a location of a preselected portion of the molten glass. For example, reflecting apparatus 14 can rotate or tilt reflecting surface 15 to direct laser beam 13 to a predetermined portion of the molten glass as reflected laser beams 17, for example.

According to one example, the regulating mechanism 16 can comprise a galvanometer that is operatively associated with the reflecting surface 15 so that the reflecting surface 15 can be rotated by the galvanometer along an axis in relation to the glass ribbon 44. For example, the reflecting surface 15 can be mounted on a rotating shaft 18 that is driven by a galvanometer motor and rotated about axis 18a as shown by double arrow 19.

In some examples, glass forming apparatus 20 includes one or more control computers (e.g., processors) that, in some examples, is configured to control laser generator 12 to direct laser beam 13 towards reflecting apparatus 14.

Further, in some examples, glass forming apparatus 20 may include one or more gas flow meters, one or more thermal cameras, and/or one or more gas supply devices. The one or more processors may be communicatively coupled (e.g., via wired or wireless connection) to the one or more gas flow meters, the one or more thermal cameras, and/or the one or more gas supply devices. Each gas flow meter may be configured to measure a pressure of the gas provided to the cavities 63 from an air supply device, and the thermal cameras may be directed to nozzle portion 61 and configured to detect a temperature of the molten glass, e.g., within cavity 24. The one or more control computers may receive gas pressure readings from the air flow meters, and may further receive temperature readings from the thermal cameras. In some examples, as described herein, the one or more control computers may receive a temperature from a thermal camera, and determine a gas pressure based on the received temperature. Further, the one or more processors may transmit a signal to a gas supply device to adjust its gas pressure output to the determined gas pressure.

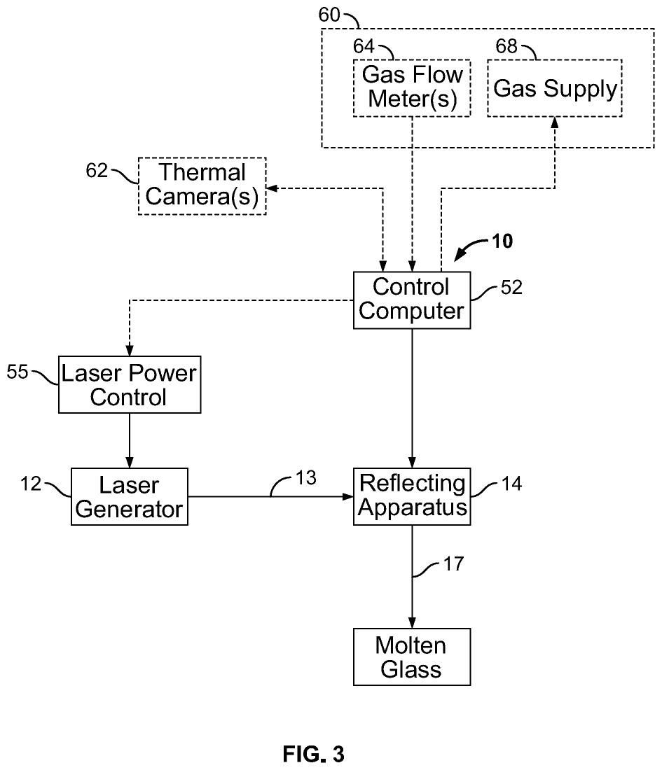

For example, FIG. 3 illustrates portions of exemplary control system 10 that includes laser power control 55 and control computer 52. Each of laser power control 55 and control computer 52 can include one or more processors, one or more field-programmable gate arrays (FPGAs), one or more application-specific integrated circuits (ASICs), one or more state machines, digital circuitry, or any other suitable circuitry. In some embodiments, one or more of laser power control 55 and control computer 52 may be implemented in any suitable hardware or hardware and software (e.g., one or more processors executing instructions stored in memory). For example, a non-transitory computer readable medium such as, for example, a read-only memory (ROM), an electrically erasable programmable read-only memory (EEPROM), flash memory, a removable disk, CD-ROM, any non-volatile memory, or any other suitable memory, may store instructions that may be obtained and executed by any one or more processors of laser power control 55 and control computer 52 to execute one or more of the functions described herein.

Laser power control unit 55 can control the operation of the laser generator 12 so that the pulse energy, beam width, power level, and/or wavelength of a laser beam 13 generated at laser generator 12 and directed towards reflecting apparatus 14 comprises preselected values. In addition, laser power control unit 55 can control the time intervals during which the laser generator 12 generates the laser beam 13. Control computer 52 is communicatively coupled to laser power control 55 and can control the operation of the laser power control unit 55 to cause laser generator 12 to generate, during preselected time intervals, a laser beam 13 having preselected wavelength and power characteristics.

Additionally, the control computer 52 may be operatively associated with the reflecting apparatus 14 to control the functioning of the regulating mechanism 16, and in a particular example where a galvanometer is employed, the motor of the galvanometer. Accordingly, the control computer 52 can be capable of adjusting the attitude and positioning of the reflecting surface 15 relative to the receipt of the laser beam 13 by the reflecting surface 15 and the locations of preselected portions of the molten glass.

For example, control computer 52 may configure regulating mechanism 16 to adjust (e.g., tilt or rotate), for preselected time periods, the reflecting surface 15 of the reflecting apparatus 14 in a plurality of varying attitudes relative to the receipt of the laser beam 13 and the reflection of the laser beam at the reflecting surface 15 of the reflecting apparatus 14. Consequently, the laser beam 13 can be directed onto a plurality of preselected portions of the molten glass during respective preselected time periods, as illustrated by the reflected laser beams 17 in FIG. 1, for example, thereby providing laser beam energy to the molten glass to control the thickness of the molten glass.

In some examples, control system 10 further includes one or more thermal cameras 62, one or more gas flow meters 64, and one or more gas supplies 68. Further, control computer 52, may be communicatively coupled to the one or more thermal cameras 62, one or more gas flow meters 64, and one or more gas supplies 68. Each thermal camera 62 may be directed to a portion of nozzle 60. In some examples, control computer 52 is configured to adjust the direction of a thermal camera 62. For example, control computer 52 may transmit a signal to a thermal camera 62 to adjust its field of view in the horizontal, or vertical, directions.

Further, control computer 52 may be configured to receive a signal from a gas flow meter identifying a current gas pressure from a gas supply 68. Based on the current gas pressure and a temperature received from a thermal camera 62, control computer 52 may determine an adjusted gas pressure for the gas supply 68. Control computer may generate and transmit to the gas supply 68 a signal identifying the adjusted gas pressure and, in response gas supply 68 may adjust the gas pressure to the adjusted gas pressure. In some examples, to determine the adjusted pressure, control computer 52 applies an algorithm to the current gas pressure and the temperature to determine the adjusted gas pressure. The algorithm may be based on empirical experiments, or on heat transfer properties and algorithms, for example.

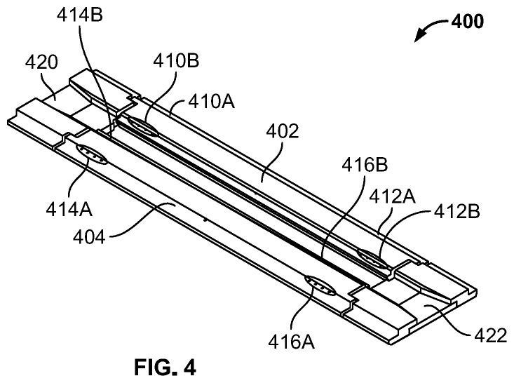

FIG. 4 illustrates an exemplary cradle assembly 400, which may be an example of the cradle assembly 218 of FIGS. 2A and 2B. Cradle assembly 400 includes a front portion 402 and a back portion 404 opposite the front portion 402. Each of the front portion 404 and back portion 406 may include a plurality of gas flow passageways that allow for the flow of a gas, such as air.

For example, front portion 402 includes entrance openings 410A and corresponding exit openings 410B, as well as entrance openings 412A and corresponding exit openings 412B. Between each entrance opening 410A, 412A and corresponding exit opening 410B, 412B is a gas flow passageway. For example, a gas tube, such as gas tube 252, may be inserted through an entrance opening 410A, 412A, proceed through a gas flow passageway, and come out of a corresponding exit opening 410B, 412B.

Similarly, back portion 404 includes entrance openings 414A and corresponding exit openings 414B, as well as entrance openings 416A and corresponding exit openings 416B. Between each entrance opening 414A, 416A and corresponding exit opening 414B, 416B is a gas flow passageway. For example, a gas tube, such as gas tube 252, may be inserted through an entrance opening 414A, 416A, proceed through a gas flow passageway, and come out of a corresponding exit opening 414B, 416B.

Further, entrance openings 410A and 414A, and corresponding exit openings 410B and 414B, are located near a first end 420 of the cradle assembly 400. Opposite first end 420 is second end 422. Entrance openings 412A and 416A, and corresponding exit openings 412B and 416B, are located near the second end 422 of the cradle assembly 400.

It may be desirable to minimize air leaks between the cradle and the nozzle to avoid perturbation in the attenuation zone. In some examples, the openings on the front side (e.g., entrance openings 410A, exit openings 410B) can advantageously be offset by a distance, such as half the pitch distance, from the openings on the back side ((e.g., entrance openings 414A, exit openings 414B), in order to provide increased spatial resolution.

In addition, in some examples, the openings located farther from the center of the cradle assembly 400 (e.g., closer to first end 420 and second 422), can be bored at a larger diameter than those closer to the center of the cradle assembly 400 to provide an outlet for the air flow coming out of the tubes. In some examples, the openings are bored at an angle versus the cooled surface such as to orient air extraction away from the center of the cradle assembly 400. Also, in some examples, cradle assembly 400 can include an insulating material, such as a fiber based insulating material, to insulate the areas of the cradle assembly from the opening closest to the center of the cradle assembly to the center of the cradle assembly 400, to minimize unnecessary air flow that could impact the temperature of the slot.

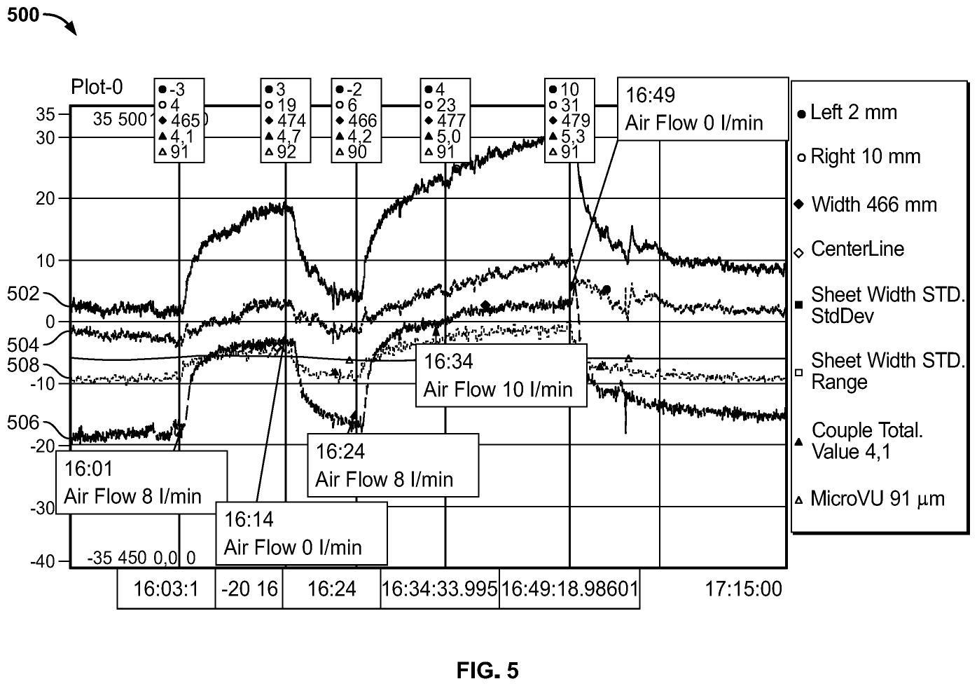

FIG. 5 is a chart 500 illustrating glass changes in sheet widths during the glass formation process when air flows (e.g., air flow pressure) to a nozzle, such as nozzle assembly 200, are applied (e.g., increased, or decreased) at various times. The air flow may be provided by, for example, gas supply 250 via one or more gas tubes 252. In this chart, first line 502 identifies changes in the width of a right side of a glass sheet, while second line 504 identifies changes in the width of a left side of a glass sheet. Third line 506 identifies the overall width of the glass sheet, and fourth line 508 identifies changes in pulling force (e.g., by pulling rolls 46 due to increased viscosity of the forming glass).

For example, at first flow rate change 520, air flow pressure is increased from 0 liters per min (l/min), to 8 l/min. As indicated by first line 502, second line 504, and third line 506, the widths of the forming glass increase. In addition, the pulling force increases. At second flow rate change 522, the air flow pressure is decreased back to 0 l/min. First line 502, second line 504, and third line 506 each indicate that the glass sheet widths then decrease, as well as the required pulling force, as indicated by the fourth line 508.

Similarly, at third flow rate change 524, the air flow pressure is once again increased to 8 l/min. Again, the widths of the forming glass increase, as indicated by first line 502, second line 504, and third line 506, and the pulling force also increases, as indicated by fourth line 508. At fourth flow rate change 526, the air flow pressure is increased from 8 l/min to 10 l/min. The widths of the forming glass further increase, as indicated by first line 502, second line 504, and third line 506, and the pulling force also further increases, as indicated by fourth line 508. At fifth flow rate change 528, the air flow pressure is decreased from 10 l/min to 0 l/min, and as a result, the widths of the forming glass decrease, as indicated by first line 502, second line 504, and third line 506. In addition, the pulling force decreases, as indicated by fourth line 508.

For a given design, heat extraction depends on air flow (as illustrated in FIG. 5), which can accurately be controlled by a flowmeter, such as a gas flow meter 64. An exemplary mass flowrate may range from 0 to 10 l/min, for example. Considering an environment where the hot zone is above 1100 Celsius, and air temperature in the jet may be below 100 Celsius, the power extracted can be up to 50 Watts, which is sufficient to generate a noticeable effect on glass viscosity. The flow density near the ends of the forming glass are relatively low and thus does not take much temperature reduction to significantly increase viscosity.

For example, at a temperature of 1100 Celsius, viscosity may be near 1.77×10⁵ Poise. As another example, at a temperature of 1125 Celsius, viscosity may be near 1.10×10⁵ Poise. An exemplary viscosity ratio may be 1.61 (viscosity/temperature).

FIG. 6 is a chart 600 illustrating the cooling impact at various portions along a slot during the glass formation process when providing air near one end of a slot. Chart 600 displays a slot 602, along with lines representing temperatures at various distances from slot center 604. As illustrated, the temperature drops more significantly near the end 606 of the slot 602 than near the center 604. For example, the difference in temperature is greater at distances greater than 160 mm from the slot center 604, than at distances less than 160 mm from the slot center 604. In some examples, cavities are bored into nozzle portions within a predetermined distance, such as within 160 mm, from a slot end 606. By increasing the number of nozzle cavities through which air is provided, heat extraction (and thus cooling) can be increased. In addition, the areas of heat extraction along the slot can be controlled by positioning cavities to receive gas adjacent those areas.

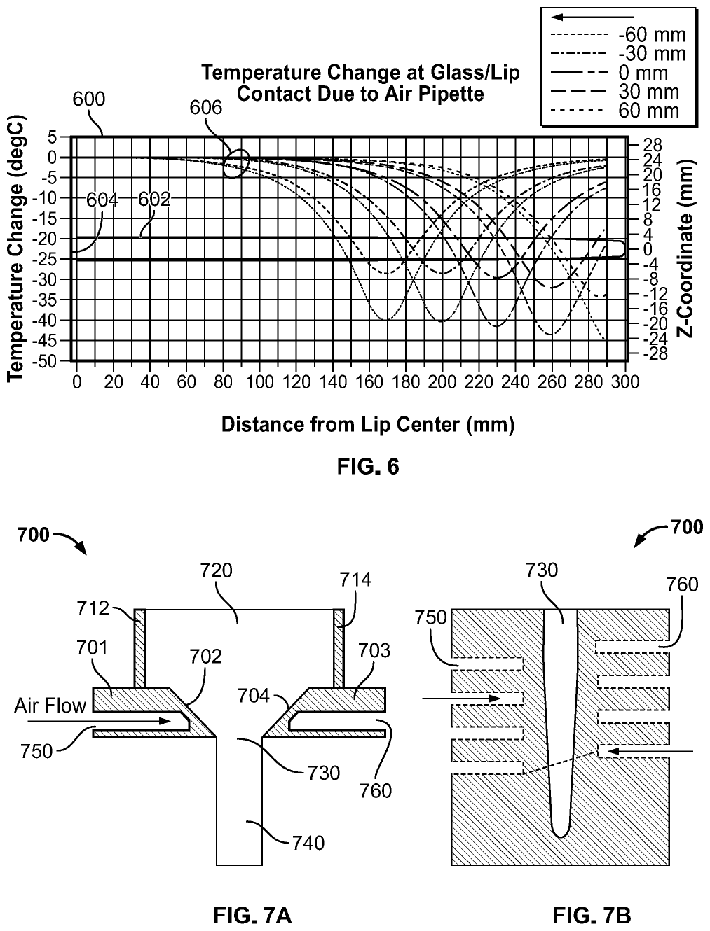

FIGS. 7A and 7B illustrate an embodiment of a nozzle assembly 700. FIG. 7A illustrates a cross section view, and FIG. 7B illustrates a top view. Nozzle assembly 700 includes a first glass forming surface 702 of a first nozzle portion 701, and a second glass forming surface 704 of a second nozzle portion 703. Second glass forming surface 704 is opposite the first glass forming surface 702. Further, nozzle assembly 700 includes a first wall 712 coupled to first glass forming surface 702, and a second wall 714 coupled to second glass forming surface 704. Between first wall 712 and second wall 714 is molten glass 720, which is guided by first wall 712, second wall 714, first glass forming surface 702, and second glass forming surface 704 to a slot 730, to produce glass ribbon 740.

Further, first nozzle portion 701 includes a plurality of first cavities 750, and second nozzle portion 701 includes a plurality of second cavities 760. Each of the plurality of first cavities 750 and plurality of second cavities 760 may receive a gas, such as from gas supply 250. As indicated in FIG. 7B, the plurality of first cavities 750 may be offset from the plurality of second cavities 760, as indicated by dashed line 770.

In some examples, cradle assembly 700 is manufactured out of a platinum alloy. In some examples, gas tubes made of metal may provide the gas from the gas supply. In some examples, the gas tubes are manufactured out of alumina.

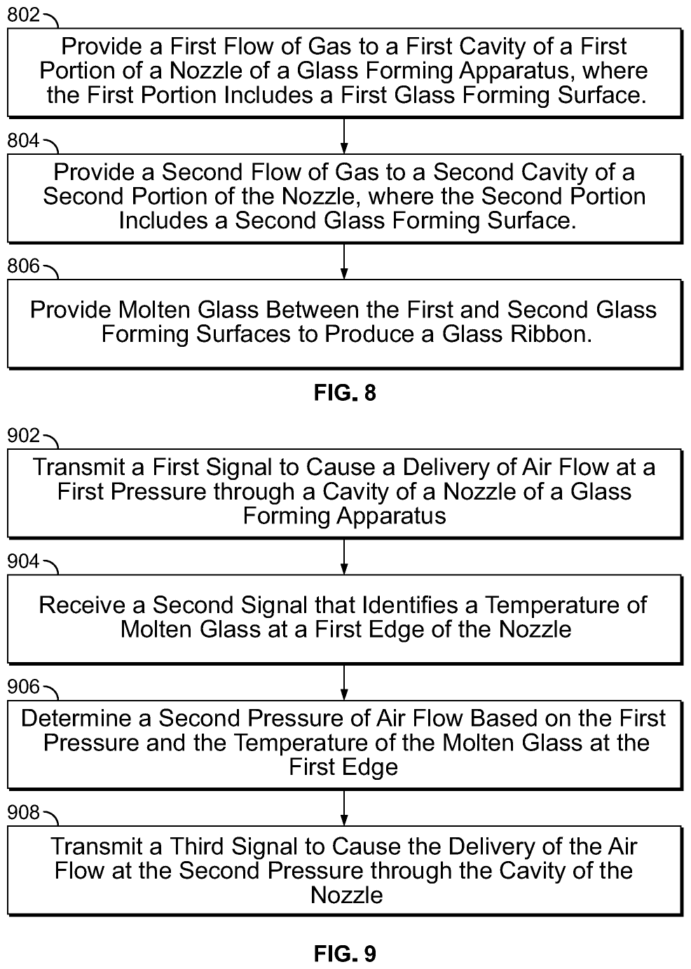

FIG. 8 illustrates an exemplary method that may be performed by a glass forming apparatus, such as glass forming apparatus 20. Beginning at step 802, a first flow of gas is provided to a first cavity of a first portion of a nozzle of the glass forming apparatus. For example, gas supply 250 may provide gas, such as air, to a cavity 63 of first nozzle portion 202 of a glass forming apparatus. The first nozzle portion 202 includes a first glass forming surface, such as first glass forming surface 212. At step 804, a second flow of gas is provided to a second cavity of a second portion of the nozzle. The second portion includes a second glass forming surface. For example, gas supply 204 may provide the gas to another cavity 63 of second nozzle portion 204, which includes a second glass forming surface 214. Further, and at step 806, molten glass is provided between the first and second glass forming surfaces to produce a glass ribbon. The method then ends.

FIG. 9 illustrates an exemplary method that may be performed by one or more computing devices, such as control computer 52. Beginning at step 902, a first signal is transmitted to cause the delivery of air flow at a first pressure through a cavity of a nozzle of a glass forming apparatus. For example, control computer 52 may transmit a signal to gas supply 250 to provide a gas at a first pressure through a cavity 63 of a nozzle 202. The method also includes receiving a second signal that identifies a temperature of molten glass at a first edge of the molten glass. For example, control computer 52 may receive a signal from a thermal camera 62 that identifies a temperature of molten glass at or near molten glass edge 48, and just below slot 34. Further, the method includes determining a second pressure of air flow based on the first pressure and the temperature of the molten glass at the first edge. For example, the control computer 52 may apply an algorithm to the first pressure and the temperature to determine the second pressure. The method also includes transmitting a third signal to cause the delivery of the air flow at the second pressure through the cavity of the nozzle. For example, the control computer 52 may transmit another signal to the gas supply 250 to provide the gas at the second pressure through the cavity 63 of the nozzle 202. The method then ends.

In some examples, a nozzle assembly for a glass forming apparatus includes a first nozzle portion, where the first nozzle portion includes a first glass forming surface. The assembly also includes a second nozzle portion opposite the first nozzle portion, where the second nozzle portion includes a second glass forming surface opposite the first glass forming surface. Further, the assembly includes a first cavity within the first nozzle portion, and a second cavity within the second nozzle portion.

In some examples, the assembly further includes a first cradle portion coupled to the first nozzle portion, and a second cradle portion coupled to the second nozzle portion. The first cradle portion includes a first gas flow passageway, and the second cradle portion includes a second gas flow passageway.

In some examples, the assembly the first gas flow passageway is configured to deliver a gas to the first cavity, and the second gas flow passageway is configured to deliver the gas to the second cavity. In some examples, the gas is air.

In some example, the assembly includes a first tube coupled to the first gas flow passageway. The first tube is configured to receive a gas from a gas supply, and provide the gas to the first gas flow passageway. In addition, a second tube is coupled to the second gas flow passageway. The second tube is configured to receive the gas from the gas supply, and provide the gas to the second gas flow passageway.

In some examples, the nozzle assembly includes a first plurality of cavities substantially parallel to the first cavity, and a second plurality of cavities substantially parallel to the second cavity.

In some examples, an apparatus includes a nozzle. The nozzle includes a first nozzle portion, where the first nozzle portion includes a first glass forming surface. The nozzle also includes a second nozzle portion opposite the first nozzle portion, where the second nozzle portion includes a second glass forming surface opposite the first glass forming surface. The apparatus also includes a first cavity within the first nozzle portion, and a second cavity within the second nozzle portion. Further, the apparatus includes at least one gas supply configured to deliver a gas to the first cavity and the second cavity. In some examples, the gas is air.

In some examples, the nozzle further includes a first cradle portion coupled to the first nozzle portion, and a second cradle portion coupled to the second nozzle portion. The first cradle portion includes a first gas flow passageway, and the second cradle portion comprises a second gas flow passageway.

In some examples, the first gas flow passageway is configured to deliver a gas to the first cavity, and the second gas flow passageway is configured to deliver the gas to the second cavity.

In some examples, the apparatus also includes a first tube coupled to the first gas flow passageway. The first tube is configured to receive a gas from a gas supply, and provide the gas to the first gas flow passageway. The apparatus further includes a second tube coupled to the second gas flow passageway. The second tube is configured to receive the gas from the gas supply, and provide the gas to the second gas flow passageway.

In some examples, the nozzle also includes a first plurality of cavities substantially parallel to the first cavity, and a second plurality of cavities substantially parallel to the second cavity.

In some examples, the apparatus includes at least one gas flow meter configured to detect a pressure of the gas delivered to the first cavity and the second cavity.

In some examples, the apparatus includes at least one processor configured to generate and transmit a signal to the gas supply to cause the gas supply to deliver the gas at a pressure.

In some examples, the apparatus includes a thermal camera configured to detect a temperature of molten glass after flowing between the first glass forming surface and the second glass forming surface.

In some examples, the apparatus includes at least one processor. The at least one processor is configured to receive a temperature from the thermal camera, and determine a pressure for the gas based on the temperature. The at least one processor is also configured to transmit a signal to the gas supply to cause delivery of the gas at the pressure.

In some examples, a method by a glass forming apparatus includes providing a first flow of gas to a first cavity of a first portion of a nozzle of a glass forming apparatus, wherein the first portion comprises a first glass forming surface. The method also includes providing a second flow of gas to a second cavity of a second portion of the nozzle, wherein the second portion comprises a second glass forming surface. Further, the method includes providing molten glass between the first and second glass forming surfaces to produce a glass ribbon. In some examples, the gas is air.

In some examples, the method also includes receiving a first signal, the first signal received from a first gas flow meter and identifying a first pressure of the first flow of gas. The method further includes receiving a second signal, the second signal received from a thermal camera and identifying a first temperature of the molten glass. The method also includes determining a first adjustment value based on the first pressure and the first temperature. Further, the method includes transmitting a third signal, the third signal transmitted to adjust the first pressure based on the first adjustment value.

In some examples, the method includes receiving a fourth signal, the fourth signal received from a second gas flow meter and identifying a second pressure of the second flow of gas. The method further includes receiving a fifth signal, the fifth signal received from the thermal camera and identifying a second temperature of the molten glass. The method also includes determining a second adjustment value based on the second pressure and the second temperature. Further, the method includes transmitting a sixth signal, the sixth signal transmitted to adjust the second pressure based on the second adjustment value.

In some examples, the first temperature is a temperature near a first end of the molten glass, and the second temperature is a temperature near a second end of the molten glass.

In some examples, the method includes transmitting a first signal to cause the first flow of gas to the first cavity of the first portion of the nozzle. The method also includes transmitting a second signal to cause the second flow of gas to the second cavity of the second portion of the nozzle.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of this disclosure. Modifications and adaptations to these embodiments will be apparent to those skilled in the art and may be made without departing from the scope or spirit of this disclosure.

What is claimed is:

1. An assembly for a glass forming apparatus comprising:
a first nozzle portion, wherein the first nozzle portion comprises a first glass forming surface;
a second nozzle portion opposite the first nozzle portion, wherein the second nozzle portion comprises a second glass forming surface opposite the first glass forming surface;
a first cavity within the first nozzle portion; and
a second cavity within the second nozzle portion.

2. The assembly of claim 1, further comprising a first cradle portion coupled to the first nozzle portion, and a second cradle portion coupled to the second nozzle portion, wherein the first cradle portion comprises a first gas flow passageway, and the second cradle portion comprises a second gas flow passageway.

3. The assembly of claim 2, wherein the first gas flow passageway is configured to deliver a gas to the first cavity, and the second gas flow passageway is configured to deliver the gas to the second cavity.

4. The assembly of claim 2, further comprising:
a first tube coupled to the first gas flow passageway and configured to:
receive a gas from a gas supply; and
provide the gas to the first gas flow passageway; and
a second tube coupled to the second gas flow passageway and configured to:
receive the gas from the gas supply; and
provide the gas to the second gas flow passageway.

5. The assembly of claim 1, further comprising a first plurality of cavities substantially parallel to the first cavity, and a second plurality of cavities substantially parallel to the second cavity.

6. An apparatus comprising:
a nozzle comprising:
a first nozzle portion, wherein the first nozzle portion comprises a first glass forming surface;
a second nozzle portion opposite the first nozzle portion, wherein the second nozzle portion comprises a second glass forming surface opposite the first glass forming surface;
a first cavity within the first nozzle portion;
a second cavity within the second nozzle portion; and
at least one gas supply configured to deliver a gas to the first cavity and the second cavity.

7. The apparatus of claim 6, wherein the nozzle further comprises a first cradle portion coupled to the first nozzle portion, and a second cradle portion coupled to the second nozzle portion, wherein the first cradle portion comprises a first gas flow passageway, and the second cradle portion comprises a second gas flow passageway.

8. The apparatus of claim 7, wherein the first gas flow passageway is configured to deliver a gas to the first cavity, and the second gas flow passageway is configured to deliver the gas to the second cavity.

9. The apparatus of claim 7, wherein the apparatus further comprises:
a first tube coupled to the first gas flow passageway and configured to:
receive a gas from a gas supply; and
provide the gas to the first gas flow passageway; and
a second tube coupled to the second gas flow passageway and configured to:
receive the gas from the gas supply; and
provide the gas to the second gas flow passageway.

10. The apparatus of claim 6, wherein the nozzle further comprises a first plurality of cavities substantially parallel to the first cavity, and a second plurality of cavities substantially parallel to the second cavity.

11. The apparatus of claim 6, wherein the apparatus comprises at least one gas flow meter configured to detect a pressure of the gas delivered to the first cavity and the second cavity.

12. The apparatus of claim 6 further comprising at least one processor configured to generate and transmit a signal to the gas supply to cause the gas supply to deliver the gas at a pressure.

13. The apparatus of claim 6 further comprising a thermal camera configured to detect a temperature of molten glass flowing between the first glass forming surface and the second glass forming surface.

14. The apparatus of claim 13 further comprising at least one processor configured to:
receive a temperature from the thermal camera;
determine a pressure for the gas based on the temperature; and
transmit a signal to the gas supply to cause delivery of the gas at the pressure.

15. The apparatus of claim 6, wherein the gas comprises air.

16. A method comprising:
providing a first flow of gas to a first cavity of a first portion of a nozzle of a glass forming apparatus, wherein the first portion comprises a first glass forming surface;
providing a second flow of gas to a second cavity of a second portion of the nozzle, wherein the second portion comprises a second glass forming surface; and
providing molten glass between the first and second glass forming surfaces to produce a glass ribbon.

17. The method of claim 16, further comprising:
receiving a first signal from a first gas flow meter and identifying a first pressure of the first flow of gas;
receiving a second signal from a thermal camera and identifying a first temperature of the molten glass;
determining a first adjustment value based on the first pressure and the first temperature; and
transmitting a third signal to adjust the first pressure based on the first adjustment value.

18. The method of claim 17, further comprising
receiving a fourth signal from a second gas flow meter and identifying a second pressure of the second flow of gas;
receiving a fifth signal from the thermal camera and identifying a second temperature of the molten glass;
determining a second adjustment value based on the second pressure and the second temperature; and
transmitting a sixth signal to adjust the second pressure based on the second adjustment value.

19. The method of claim 18, wherein the first temperature is near a first end of the molten glass, and the second temperature is near a second end of the molten glass.

20. The method of claim 16, further comprising
transmitting a first signal to cause the first flow of gas to the first cavity of the first portion of the nozzle; and
transmitting a second signal to cause the second flow of gas to the second cavity of the second portion of the nozzle.
